(19) United States
(12) Patent Application Publication
(10) Pub. No.: US 2003/0137981 A1
(43) Pub. Date: Jul. 24, 2003

(54) Switch controller controlled by a link layer protocol and control method thereof

(76) Inventors: Yin-Hsin Tsai, Hsinchu (TW); Hung-Yu Wu, Tao Yuan (TW); Chun-Feng Liu, Taipei (TW); Chih-Ching Wang, TaiChung (TW); David Lu, Tao Yuan (TW); Jiam-Shiun Tung, TaiChung (TW); Jin-Ru Chen, TaiChung (TW)

Correspondence Address: Raymond Sun, 12420 Woodhall Way, Tustin, CA, 92782, US

(21) Appl. No.: 10/324,575

(22) Filed: Dec. 19, 2002

(30) Foreign Application Priority Data
Dec. 31, 2001 (TW) 90133497

(51) Int. Cl. H04L 12/28

(52) U.S. Cl. 370/392

(57) ABSTRACT

A switch controller controlled by a Link layer protocol is provided. The controller does not occupy any IP address, and is capable of parsing control frames based on the Link layer protocol. The controller comprises: a reception unit for receiving a packet; a parsing unit for parsing a control frame in the packet and for generating a control signal based on the control frame; a packet buffer for storing the packet; a protocol-processing unit for modifying the control frame based on the control signal; and a transmission unit for transmitting the packet after being processed by the protocol-processing unit.

### BACKGROUND OF THE INVENTION

(a). Field of the Invention

The present invention relates in general to a switch control protocol and a switch controller conforming to it, and more particularly to a switch control protocol used for network administration and configuration, and a switch controller controlled by a Link layer protocol without using an Internet Protocol (IP) address.

(b). Description of the Prior Arts

In a local area network (LAN), a network switch or hub is used to connect computers and servers in the LAN for rapid transmission and sharing of information. Since the switch processes and transmits data much faster than the hub, the former is increasingly universal in use.

The International Organization for Standardization (ISO) defined an Open System Interconnection (OSI) reference model that embodies a structure of seven layers, which from bottom to top are as follows: Physical layer, Link layer, Network layer, Transport layer, Session layer, Presentation layer, and Application layer. A layer of a network node (e.g. a computer or switch) communicates with the same layer of another connected node by using associated protocols. The Physical layer is also referred to as Layer 1 and transmits data at bit level by using network hardware. The Link layer, also called Layer 2, provides reliable service of data transmission by organizing the data into frames transmitted with the help of error handling and flow control. The Network layer (Layer 3) specifies how addresses are assigned and how packets are forwarded from one end of the network to another.

An Ethernet header of the Link layer is 14 bytes long and comprises below fields:

(1) Destination Address (DA) field: defined as a Destination Media Access Control (DMAC) address that is 6 bytes long; that is, the DA field of a frame contains the MAC address of a network node which receives the frame;

(2) Source Address (SA) field: defined as a Source Media Access Control (SMAC) address that is 6 bytes long; that is, the SA field of a frame is the MAC address of a network node that transmits the frame;

(3) Ether Type field: 2 bytes long, used for indicating which protocol a control frame conforms to.

FIG. 1 is a diagram depicting basic architecture of a common local area network. As shown in FIG. 1, several personal computers (PCs) and a server are connected through a hub 13, a dumb switch 14 and an intelligent switch 15, and a router 16 is used to connect the local area network to Internet.

Conventional switches can be roughly divided into two types: one is the intelligent switch, also called Layer 3 switch, with a central processing unit (CPU) inside, and the other is the dumb switch, also called Layer 2 switch, without a CPU.

The intelligent switch determines if the protocol indicated by the Ether Type field of an Ethernet header is a known one and parses subsequent fields based on the known protocol. However, in order to grasp the whole network topology, it is still necessary to parse IP headers of received packets, wherein the IP headers belong to the Network layer and are 20-60 bytes long. Hence, an IP address is needed for the intelligent switch to receive the packets. Besides, the intelligent switch executes associated control software with the help of an internal CPU and allows a remote node to configure the switch via a user interface, thereby facilitating network administration. But the intelligent switch costs higher just because of the built-in CPU.

On the contrary, the dumb switch only parses the DA and SA fields of the Ethernet header without need to use a CPU, thus it costs lesser. However, since subsequent fields of the Ethernet header are not parsed, information about the whole network topology cannot be obtained and the switch cannot also be configured through a user interface.

### SUMMARY OF THE INVENTION

In view of the issue mentioned above, the present invention provides a switch control protocol of the Link layer that allows network administrators to access information about a switch controller knowing the control protocol, to configure its internal architectural registers, and to maintain network security through a user (or management) interface without the help of a CPU and without occupying any IP address.

The above switch controller comprises: a reception unit for receiving a packet; a parsing unit for parsing a control frame in the packet and for generating a control signal based on the control frame; a packet buffer for storing the packet temporally; a protocol-processing unit for performing an associated operation based on the control signal; and a transmission unit for transmitting the packet after being processed by the protocol-processing unit.

In addition to DA, SA and Ether Type fields of the common Ethernet header, a control frame according to the control protocol of the present invention further comprises:

1. Protocol field: 1 byte long, used to indicate that the control frame conforms to the control protocol;

2. OP Code field: 1 byte long, used to specify an operation for the control frame and divided into a 7-bit Operation Code field and a Reply bit, wherein the Reply bit is used to determine if the control frame is an instruction of reply type;

3. Authentication key field: 2 bytes long, used to define the authentication key of the control frame;

4. Register Address field: 2 bytes long, used to specify the register address required by the control frame;

5. Register Data field: 4 bytes long, used to record data included in the specified register address; and

6. Uplink MAC field: 6 bytes long, used to define the MAC address of an uplink switch.

To sum up, the above switch controller enables network administrators to access and set parameters of the switch via a user interface by parsing control frames based on the control protocol of the present invention, though the controller neither contains a CPU nor occupies any IP address.

### BRIEF DESCRIPTION OF THE DRAWINGS

FIG. 1 is a diagram depicting basic architecture of a common local area network.

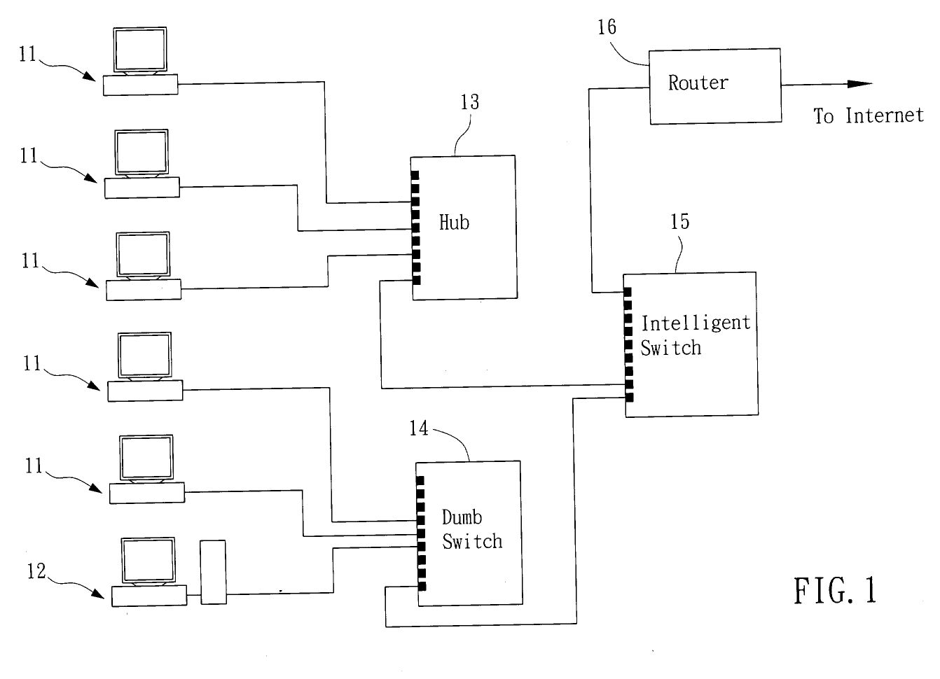

FIG. 2 is a diagram depicting the control frame format for the Hello, Get, Get Reply and Set instructions.

FIG. 3 is a diagram depicting the control frame format for the Hello Reply instruction.

FIG. 4 is a block diagram of a switch controller of the present invention.

FIG. 5 is a flow chart of packet reception by a switch controller of the present invention.

FIG. 6 is a diagram featuring one embodiment of the action flow of the parsing unit.

### DETAILED DESCRIPTION OF THE PRESENT INVENTION

This section will provide a detailed description with one preferred embodiment and appended drawings to make the goals and features of the present invention more apparent and easy to understand.

The switch control protocol of the present invention supports several control operations as below: Hello, Hello Reply, Get, Get Reply and Set. The control protocol allows a management station to handle data packets of switches of the same physical network domain via a user interface.

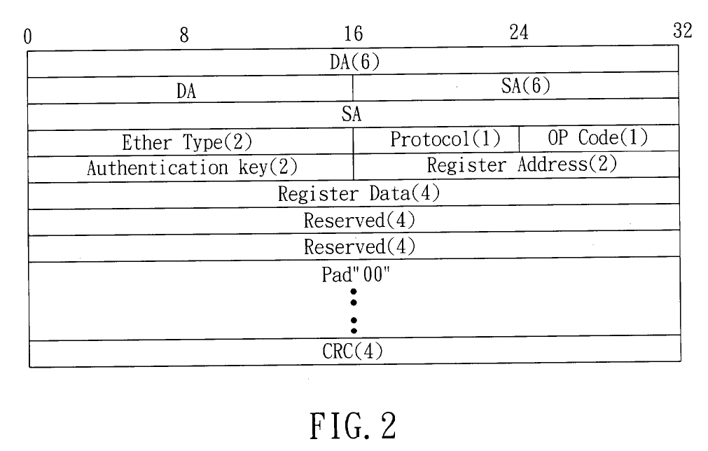

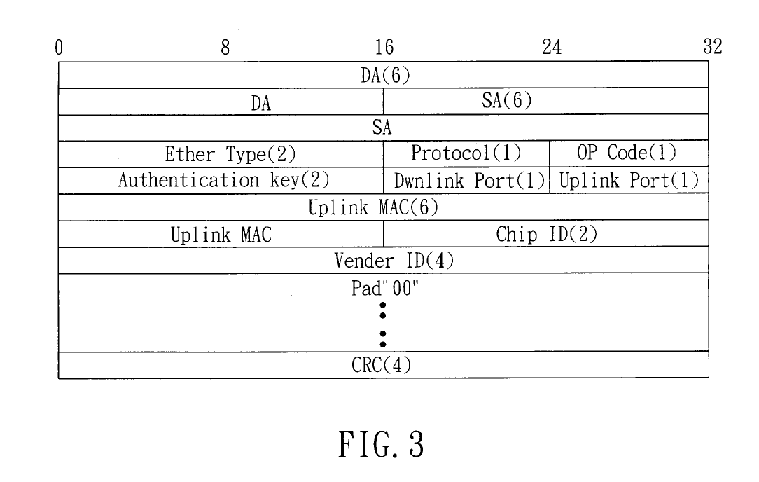

Based on different control operations, the control protocol provides two types of control frame formats both of which contain DA, SA and Ether Type fields of the conventional Ethernet header. One type is referred to as Format I, which is used for the control operations of Hello, Get, Get Reply and Set, as shown in FIG. 2. The other type is referred to as Format II, which is used for the control operation of Hello Reply, as shown in FIG. 3. A detailed description is provided as below for the definition and length of various fields in the control frame formats:

1. DA field: defined as a DMAC address that is 6 bytes long. If OP Code field indicates a Get or Set control frame, then the DA field specifies the address of a switch to be read or set. If the OP Code field indicates a Get Reply control frame, then the DA field specifies the address of a management station. If the OP Code field indicates a Hello control frame, then the DA field specifies either the unicast address of a switch or a broadcast address for all nodes knowing the control protocol.

2. SA field: defined as an SMAC address that is 6 bytes long; that is, the SA field of a control frame contains the MAC address of a switch or management station that transmits the control frame.

3. Ether Type field: 2 bytes long, used to indicate which type an Ethernet control frame belongs to. Only when the Ether Type field of a control frame contains a registered valid Ether Type value of a vendor, the frame would be processed. The valid Ether Type value can be stored in an EEPROM of a switch for easy updating.

4. Protocol field: 1 byte long, used to specify which protocol a control frame conforms to. The value of this field is now defined as “01” and other values are reserved for future expansion.

5. OP Code field: 1 byte long, divided into an 7-bit Operation Code field and a Reply bit, wherein the Operation Code field is used to specify an operation for a control frame and the Reply bit is used to determine if the control frame is an instruction of a reply type.

When a control frame is an instruction of a reply type replied by a downlink switch controller to an uplink switch controller, the reply bit would be set as “1”; when the control frame is an instruction of a non-reply type transmitted by the uplink switch controller to the downlink switch controller, the reply bit would be set as “0”. The OP Code field specifies an operation a control frame would perform: “00H” indicating a Hello frame, “80H” indicating a Hello Reply frame, “01H” indicating a Get frame, “81H” indicating a Get Reply frame, and “02H” indicating a Set frame.

6. Authentication key field: 2 bytes long, used to define the authentication key of a control frame and to maintain network security. This field is set as a same default value for all nodes knowing the control protocol of the present invention. The authentication key can be modified by using a Set frame. A switch is not responsive to a control frame with a valid DA and a different authentication key, but if the DA of a specific frame replied to the control frame is a broadcast address or directed to another switch, then the switch still performs normal Layer 2 switch behavior.

7. Register Address field: 2 bytes long, used to specify the register address required by a control frame.

8. Register Data field: 4 bytes long, used to record data stored in the register with an address specified in the Register Address field.

9. Dwnlink Port field: 1 byte long, used to define the downlink port number of a link vector. A downlink switch controller, which transmits a Hello Reply frame to an uplink switch, sets this field as the number of the port connected to the uplink switch. 10. Uplink Port field: 1 byte long, used to define the uplink port number of the link vector. The value of this field is predetermined as 00H and updated by the uplink switch controller as the number of the port of the uplink switch connected to the downlink switch transmitting the Hello Reply frame.

11. Uplink MAC field: 6 bytes long, used to define the MAC address of an uplink switch. The value of this field is predetermined as “000000H” and updated by an uplink switch controller. When a switch receives a frame whose Uplink MAC field contains the default value, the switch would fill the MAC address of itself into the Uplink MAC field.

12. Chip ID field: 2 bytes long, used to define the processing chip ID of a switch controller. Each switch controller knowing the switch control protocol of the present invention is rendered a unique chip ID that is recorded in an EEPROM of the controller and is assigned based on Realtek switch controller's data sheet.

13. Vendor ID field: 4 bytes long, reserved for system vendors and used to specify company names of the vendors or device types.

Based on the above fields, administrators can grasp the whole network topology and configure each switch by connecting to a management station in a local area network. Hence, as long as a switch is equipped with a packet buffer for storing packets of the Link layer, users can utilize the packet buffer to set or get the configuration of the switch according to the instructions of the control protocol. It must be stressed here that a switch controller knowing the control protocol of the present invention is a slave one, whose actions need to be acknowledged and executed via a management interface by administrators. For example, if the administrators carry out the operations of (1) Get and (2) Hello via the management interface, then the slave switch controller would respond to them by providing (1) a Get Reply frame and (2) a Hello Reply frame. Therefore, the administrators can comprehend the topology of the local area network through the switch control protocol of the present invention.

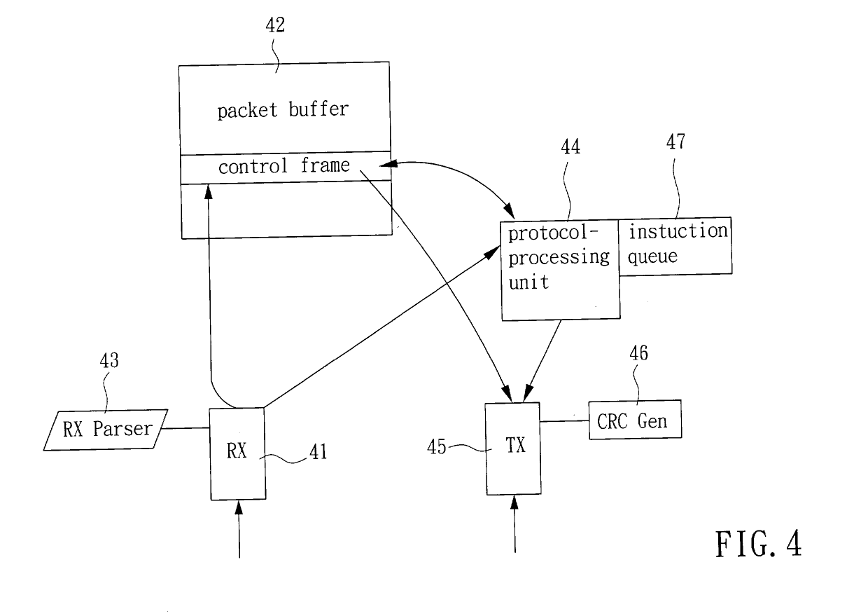

A detailed description is provided below to explain which actions to take for a switch controller when it receives frames specifying the control operations of (1) Set, (2) Get and (3) Hello defined by the control protocol. The actions of the switch controller can be implemented in an application-specific integrated circuit (ASIC). FIG. 4 is a block diagram of a switch controller of the present invention. As shown in FIG. 4, the switch controller comprises a reception unit 41, a packet buffer 42, a parsing unit 43, a protocol-processing unit 44, an instruction queue unit 47, a transmission unit 45, and a cyclic redundancy check (CRC) generation unit 46. When the reception unit 41 receives a packet, the received packet is stored in an empty control frame of the packet buffer 42; meanwhile, the parsing unit 43 parses the packet format to check if the packet conforms to the control protocol of the present invention, i.e. to determine if the Protocol field of the packet indicates the control protocol. If checking result of the parsing unit 43 is negative, the transmission unit 45 would read the packet from the packet buffer 42 for transmission. If the checking result of the parsing unit 43 is positive, then the parsing unit 43 would provide the parsed fields of the packet or the index of the control frame stored in the packet buffer 42 to the protocol-processing unit 44. Next, the protocol-processing unit 44 performs the actions associated with the parsed fields of the packet. For example, if the OP Code field specifies a Get Reply or Hello Reply operation, the protocol-processing unit 44 would modify the fields of the control frame in the packet buffer 42, and the transmission unit 45 would read the modified frame from the packet buffer 42, handle it with the help of the CRC generation unit 46, and then send to an uplink switch. If the OP Code field specifies a Set operation, then the protocol-processing unit 44 would configure internal registers of the switch controller based on the Register Address and Register Data fields.

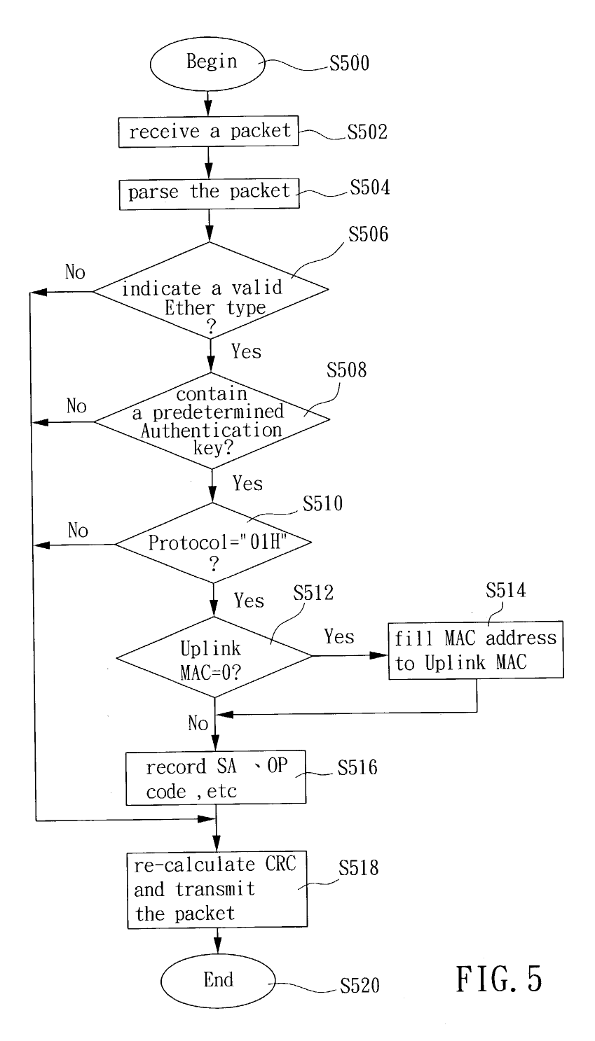

FIG. 5 shows a flow chart of packet reception by a switch controller of the present invention. The steps are as below:

S500 the flow beginning;

S502 receiving a packet;

S504 parsing the packet;

S506 determining if the Ether Type field of the packet indicates a valid Ethernet type, if yes then jumping to step S508, if no then jumping to step S518;

S508 checking if the Authentication key field of the packet contains a predetermined value, for instance 8899, if yes then jumping to step S510, if no then jumping to step S518, wherein the predetermined value can be changed for various conditions;

S510 checking if the protocol field of the packet is equal to a default value “01H”, if yes then jumping to step S512, if no then jumping to step S518, wherein the default value can be changed for various conditions;

5512 checking if the Uplink MAC field of the packet is zero, if yes then jumping to step S514, if no then jumping to step S516;

S514 filling the MAC address of the switch controller to the Uplink MAC field and then jumping to next step;

S516 recording the SA, OP Code, Register Address, and Register Data fields of the packet and then jumping to next step;

S518 re-calculating CRC of the packet and then making a reply to an administrator; and

S520 the flow ending.

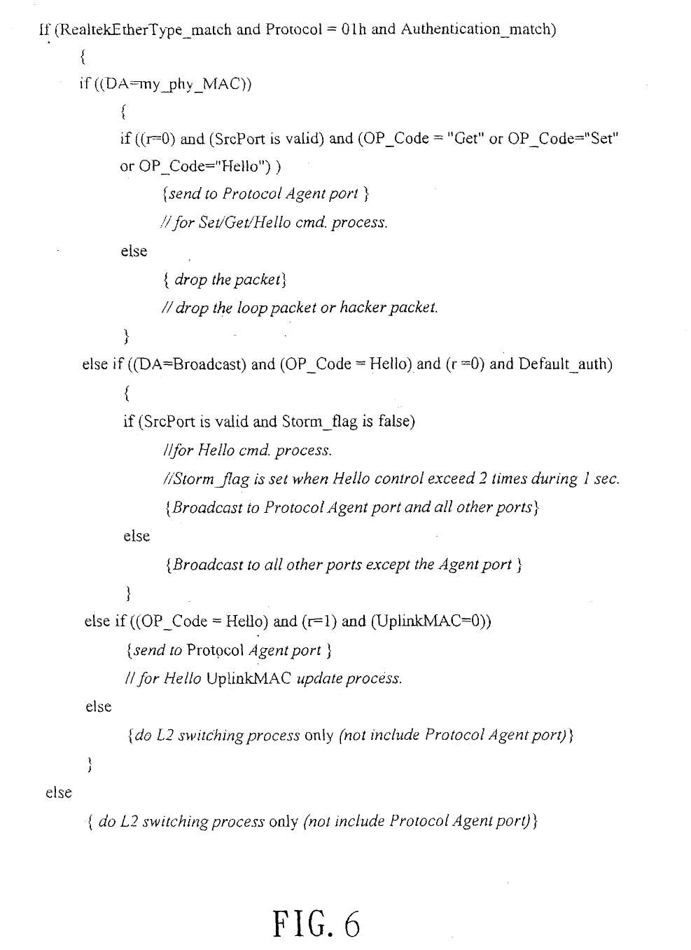

FIG. 6 is a diagram featuring one embodiment of the action flow of the parsing unit 43. As shown in FIG. 6, when a switch controller detects a Get frame (OP Code=01H), the controller would perform a Get Reply operation and provide a Get Reply frame to an administrator. The flow of the Get Reply operation is as follows:

(1). Reading the Register Address field of the Get frame and filling data stored in the register with the address therein into the Register Data field of the frame.

(2). Setting the Reply bit of the Get Reply frame as 1.

(3). Filling the value of the SA field into the DA field of the Get Reply frame.

(4). Filling the MAC address of the controller itself into the SA field of the Get Reply frame.

(5). Re-calculating CRC for the modified Get Reply frame and then replying it to the administrator.

When the switch controller detects a Set frame (OP Code=02H), the controller would perform a Set operation whose flow is as follows:

(1). Reading the Register Address and Register Data fields of the Set frame and filling data of the Register Data field into an internal register of the controller, wherein the address of the register is just specified in the Register Address field.

(2). Finishing the Set operation.

When the switch controller detects a Hello frame (OP Code=00H), the controller would perform a Hello Reply operation and provide a Hello Reply frame to the administrator. The flow of the Hello Reply operation is as follows:

(1). copying the received Hello frame to the packet buffer and configuring the copied frame with the format of a Hello Reply frame for subsequent modification.

(2). Set the Reply bit of the configured frame as 1.

(3). Filling the value of the SA field into the DA field of the configured frame.

(4). Filling the MAC address of the controller itself into the SA field of the configured frame.

(5) Filling the port number receiving the original Hello frame into the Dwnlink Port field of the configured frame.

(6) Filling the chip ID into the Chip ID field of the configured frame.

(7) Filling the vendor ID into the Vendor ID field of the configured frame.

(8) Waiting for a random length of time.

(9) Re-calculating CRC of the modified frame and then sending the modified frame to the administrator.

The MAC update procedure for an uplink switch controller is as below:

(1) Filling the port number of the uplink switch controller into the Uplink Port field of the Hello Reply frame.

(2) Setting the Uplink MAC field of the Hello Reply frame as the MAC address of the uplink switch controller itself.

(3) Re-calculating CRC of the modified frame and then sending the modified frame to the administrator.

As to network security, a control instruction is executed only if the Authentication key of a control frame conforms to a value preset by network administrators.

While the present invention has been shown and described with reference to one preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the sprit of the present invention.

What is claimed is:

1. A switch controller controlled by a Link layer protocol, comprising:
a reception unit receiving at least one packet;
a parsing unit parsing the packet, wherein if the packet contains a control frame conforming to the Link layer protocol and the switch controller is a destination of the control frame, then the parsing unit generates a corresponding control signal;
a packet buffer storing the packet;
a protocol-processing unit, which accesses a configuration of the switch controller and selectively generates a reply frame conforming to the Link layer protocol, wherein the reply frame is generated by modifying the control frame; and
a transmission unit, which sends out the reply frame and selectively transmits the packet out of the packet buffer.

2. The switch controller as recited in claim 1, wherein the switch controller does not occupy any IP address.

3. The switch controller as recited in claim 1, wherein the switch controller operates without a central processing unit (CPU).

4. The switch controller as recited in claim 1, wherein the parsing unit checks whether an Ether Type field of the control frame contains a valid value, and the control frame is processed only if a result of the check is positive, otherwise the transmission unit transmits the packet out of the packet buffer.

5. The switch controller as recited in claim 4, wherein the valid value is defined in an EEPROM of the switch controller for modification and supplement.

6. The switch controller as recited in claim 4, wherein if the result of the check is positive, then the protocol-processing unit performs an operation specified in an OP Code field of the control frame.

7. The switch controller as recited in claim 1, wherein the control frame and the reply frame comprises a destination address (DA) field, a source address (SA) field, an Ether Type field, and an OP Code field, wherein the OP Code field of the control frame specifies one of a plurality of control operations for the control frame, and the OP Code field of the reply frame specifies one of a plurality of reply operations for the reply frame.

8. The switch controller as recited in claim 7, wherein the plurality of control operations comprise Get, Hello and Set while the plurality of reply operations comprise Get Reply and Hello Reply.

9. The switch controller as recited in claim 8, wherein if the OP Code field of the control frame specifies the Get/Hello operation, then the reply frame is generated by the protocol-processing unit to perform the Get Reply/Hello Reply operation; if the OP Code field of the control frame specifies the Set operation, then the reply frame is not generated.

10. The switch controller as recited in claim 8, wherein if the OP Code field of the control frame specifies the Get/Set operation, then the DA field of the control frame contains an address of the switch controller; if the OP Code field of the reply frame specifies the Get Reply/Hello Reply operation, then the DA field of the reply frame contains an address of a management station; and if the OP Code field of the control frame specifies a Hello operation, then the DA field of the control frame contains the address of the switch controller or a broadcast address.

11. The switch controller as recited in claim 7, wherein the OP Code field comprises an operation code field and a Reply bit, wherein the Reply bit of the control frame is clear and the Reply bit of the reply frame is set.

12. The switch controller as recited in claim 7, wherein the control frame and the reply frame further comprises:
a Protocol field indicating if the control/reply frame conforms to the Link layer protocol;
an Authentication key field defining an authentication key of the control/reply frame.

13. The switch controller as recited in claim 12, wherein the Authentication key field contains a default value which can be modified by the control frame performing the Set operation, and the switch controller does not process a first control frame whose Authentication key is different from the default value unless DA of the first control frame is a broadcast address or directed to another switch.

14. The switch controller as recited in claim 9, wherein the control frame and the reply frame performing the Get Reply operation further comprise:
a Register Address field defining an address of a register within the switch controller; and
a Register Data field storing data of the register within the switch controller.

15. The switch controller as recited in claim 14, wherein if the Set operation is specified for the control frame, then the protocol-processing unit, in response to the control signal, stores data within the Register Data field of the control frame into the register defined in the Register Address field of the control frame.

16. The switch controller as recited in claim 14, wherein if the Get operation is specified for the control frame, then the protocol-processing unit, in response to the control signal, stores data within the register defined in the Register Address field of the control frame into the Register Data field of the control frame and fills the SA of the control frame and an address of the switch controller itself into the DA and SA fields of the control frame respectively, thereby generating the reply frame performing the Get Reply operation.

17. The switch controller as recited in claim 9, wherein the reply frame performing the Hello Reply operation further comprises:
a Dwnlink Port field defining a downlink port number of a link vector, wherein the switch controller is a downlink node of the link vector;
an Uplink Port field defining an uplink port number of the link vector; and
an Uplink MAC field defining a MAC address of an uplink switch controller of the link vector.

18. The switch controller as recited in claim 17, wherein if the Hello operation is specified for the control frame, then the protocol-processing unit, in response to the control signal, generates the reply frame performing the Hello Reply operation, wherein the SA of the control frame and an address of the switch controller itself are filled into the DA and SA fields of the reply frame respectively, and the Dwnlink Port field of the reply frame is set as the downlink port number of the switch controller connecting to the uplink switch controller.

19. The switch controller as recited in claim 18, wherein the Uplink Port field is updated by the uplink switch controller as the uplink port number of the uplink switch controller connecting to the switch controller, and the Uplink MAC field contains a predetermined value and is updated by the uplink switch controller as the MAC address of the uplink switch controller itself.

20. A method for controlling a switch controller by a Link layer protocol comprising:
receiving a packet and storing the packet to a packet buffer;
checking whether the packet contains a control frame conforming to the Link layer protocol and the switch controller is a destination of the control frame, wherein if a result of the check is negative, then transmitting the packet out of the packet buffer and ending the method, and if the result is positive, then generating a control signal and continuing below steps;
modifying the control frame based on the control signal, if a Get/Hello operation is specified for the control frame, to generate and transmit a reply frame which conforms to the Link layer and performs a Get Reply/Hello Reply operation; and
configuring the switch controller based on the control signal if a Set operation is specified for the control frame.
